(19) United States
(12) Patent Application Publication
(10) Pub. No.: US 2024/0398043 A1
(43) Pub. Date: Dec. 5, 2024

(54) PERSONAL VAPORIZER NEAR FIELD COMMUNICATION BATCH WRITING

(71) Applicant: Kyle D. Newton, Euless, TX (US)

(72) Inventor: Kyle D. Newton, Euless, TX (US)

(21) Appl. No.: 18/204,100

(22) Filed: May 31, 2023

(51) Int. Cl. A24F 40/65; A24F 40/42; G06K 7/10; H04B 5/00

(52) U.S. Cl. CPC A24F 40/65; A24F 40/42; G06K 7/10297; H04B 5/72; H04B 5/77

(57) ABSTRACT

The present disclosure involves systems, methods, and an apparatus for batch writing NFC tags in a personal vaporizer cartridge and updating a database to track the tags. This includes receiving a target uniform resource locator (URL) and batch size for a plurality of near field communication (NFC) tags at a batch writing device. A plurality of unique ID's, each corresponding to a particular NFC tag in the plurality of NFC tags is generated. The batch writing device detects the presence of an NFC tag and in response generates a unique URL based on the target URL and a particular unique ID, writes the unique URL to the NFC tag, and updates a database entry associated with the particular unique ID with the detected NFC tag.

### BACKGROUND

Personal vaporizers provide an alternative to smoking techniques which involve combustion of organic matter and inhalation of the vapor. Instead, vaporizers atomize a substance (e.g., a nicotine substance or cannabis substance) using a heating element to simulate the combustion found in traditional cigarettes. Personal vaporizers often use removable/replaceable cartridges containing a substance for atomization. Different substances may require different heating profiles for improved vaporization.

### SUMMARY

The present disclosure involves systems, methods, and an apparatus for batch writing NFC tags in a personal vaporizer cartridge and updating a database to track the tags. This includes receiving a target uniform resource locator (URL) and batch size for a plurality of near field communication (NFC) tags at a batch writing device. A plurality of unique ID's, each corresponding to a particular NFC tag in the plurality of NFC tags is generated. The batch writing device detects the presence of an NFC tag and in response generates a unique URL based on the target URL and a particular unique ID, writes the unique URL to the NFC tag, and updates a database entry associated with the particular unique ID with the detected NFC tag.

Implementations can optionally include one or more of the following features.

In some instances, the plurality of NFC tags are associated with a cartridge of a personal vaporizer, and a cartridge type associated with the plurality of NFC tags is received. The unique URL can be generated based on the cartridge type.

In some implementations, updating the database entry includes generating a new database entry.

In some implementations, a completion message is sent upon writing each unique URL to each NFC tag.

In some implementations, the database is a web based database and the batch writing device updates the database entry using a network.

In some implementations, the unique URL points to a webpage that is specific to the particular unique ID. In some implementations the webpage includes settings associated with a cartridge of a personal vaporizer.

The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 depicts a perspective view of an example implementation of a batch NFC writer and database manager.

FIG. 2 is a simplified schematic block diagram of an example batch NFC writer and database manager.

FIG. 3 is a flowchart illustrating an example process for batch writing NFC tags.

FIG. 4 illustrates a schematic diagram of some internal components of an example personal vaporizer cartridge.

### DETAILED DESCRIPTION

This disclosure describes a batch writer and database manager for rapidly writing to a large number of NFC tags that are installed in vaporizer cartridges. A personal vaporizer such as an electronic cigarette, a vape pen, vape kits, e-cig, or e-hookah, electronic nicotine delivery system can include a power supply portion that operates a disposable cartridge portion. The cartridge portion includes a reservoir containing the substance to be vaporized and a heating element. However, different substances may require different operational parameters, as well as have different governmental regulation requirements. In some instances, near field communications (NFC) tags can be installed in each cartridge and contain a uniform resource locator (URL) that links to a database storing details of the particular cartridge. The power supply portion can read the NFC tag, access the URL, and update operational settings accordingly. In order to track each individual cartridge as it is sold, even where new ones are developed, the database must be flexible enough to allow a manufacturer to add new entries, and categories of entries, while still uniquely identifying the cartridge. Additionally, each cartridge's NFC tag must have a unique URL written to it, to allow the power supply portion to access information specifically associated with that cartridge.

A batch writer, which can automatically generate unique identifications (ID's) and update or submit the ID along with the associated cartridge type to a database, enables cartridge manufacturers to rapidly and easily generate the required database and track the usage and/or inventory of cartridges in real or near real-time. The manufacturer, or user of the batch writer can input a batch size, target URL to which the database entries should be submitted, and cartridge type or operational settings associated with the cartridges to be written to. The batch writer can then generate a number of unique ID's for each cartridge to be written to, and automatically write the tags as they pass through the batch writer's field of influence, communicate with, and update a database. Each written tag can include the unique ID and the target URL, and the database can associate the ID with one or more operational settings and/or the cartridge type that the ID was written to.

The disclosed solution has numerous technical advantages. For example, by uniquely ascribing each cartridge with a unique ID that is maintained in a database, by requiring the end user to register that cartridge before use, the manufacturer can track which cartridges that have been sold are in use, have been consumed, or are yet to be consumed, and monitor or prevent unauthorized re-use or re-sale of cartridges. In another example, by maintaining the cartridge settings in a database that is separate from the associated NFC tag on the cartridge, the operational settings can include more data than is available within the capacity of an NFC tag. Further the data can be changed, updated, or improved without recalling or modifying what has been written to the NFC tag. Additionally, the batch writer can be configured to automated, alleviating the need for an operator to manually enter information and update the database with each batch of NFC tags to be written.

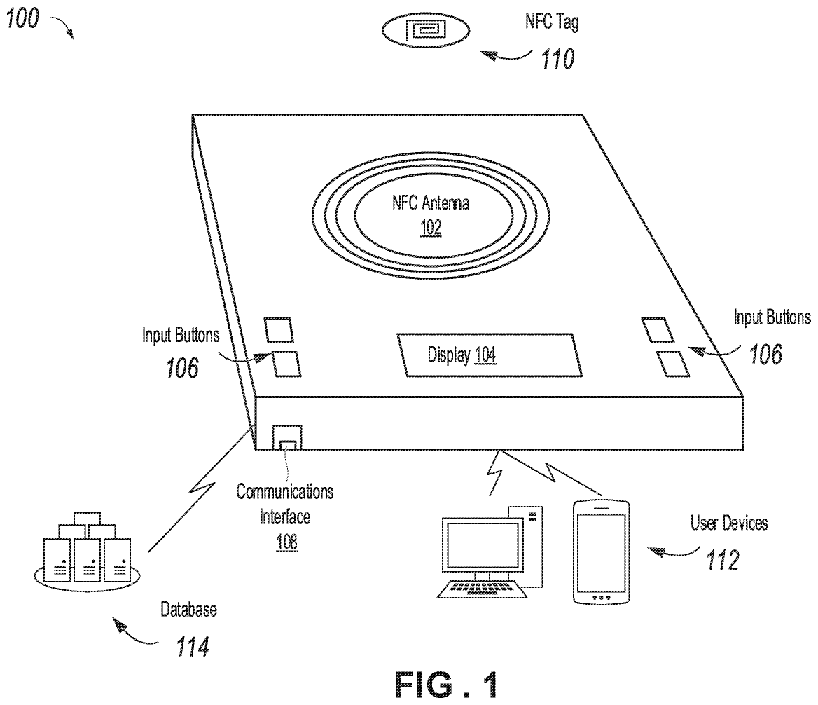

Turning to the illustrated example implementation, FIG. 1 is a perspective view of an example implementation of a batch NFC writer and database manager 100. Batch writer 100 includes an NFC antenna 102, a display 104, one or more input buttons 106, and a communications interface 108.

The NFC antenna 102 can be a series of loops that are sized to inductively couple with a similar antenna in the NFC tag 110 that is being written to (or read from). In general, the NFC antenna 102 is operable to communicate with other NFC antennae at approximately 13.56 MHz and at ranges of around 10 cm. In some implementations, the batch writer 102 transmits polling or interrogation signals periodically, using the NFC antenna 102, in order to determine whether the antenna 102 is inductively coupled with an NFC tag 110. In other words, the antenna 102 can be used to sense whether another NFC antenna is within range of the batch writer 100 in order for the batch writer 100 to write or otherwise communicate.

Batch writer 100 optionally includes a display 104, which can provide information regarding the status of writing, messages being written, or generally provide for a user interface with the batch writer 100. The display 104 can be a device such as a CRT (cathode ray tube), OLED (organic LED), or LCD (liquid crystal display) monitor for displaying information to the user. Additionally, the display 104 can include input capabilities such a touchscreen flat-panel displays and other appropriate mechanisms. In some implementations, batch writer 100 does not include a display 104, or uses a remote display. For example, batch writer 100 may provide information to a user via a display on a different device, such as a personal computer, or smartphone that is in communication with batch writer 100.

One or more input buttons 106 can be used to manipulate or provide commands to the batch writer 100. In some implementations, input buttons 106 can include a connect, start, stop, select, left, right, up, down, or other appropriate buttons. In some implementations, a power button is provided. Buttons 108 can be toggles, or soft-keys (e.g., associated with a touchscreen), or other suitable input devices.

A communications interface 108 can be provided to enable the batch writer 100 to communicated with external devices and/or networks. For example, communications interface 108 can be used to communicate with various user devices 112, such as a smartphone of or personal computer. In some implementations, where the batch writer maintains a remote database 114, the communications interface 108 can be used to facilitate communication between the database 114 and the batch writer 100. The communications interface 108 can be, for example, an Ethernet port, universal serial bus (USB) port, or other communications port. In some implementations, communications interface 108 is a wireless communications interface, such as Bluetooth, WiFi, or other communications interface. While only a single port is illustrated, implementations with multiple communications interfaces 108 are within the scope of this disclosure. In some implementations, a separate power port (not shown) is provided, that can be, for example, a coaxial power connector. In some implementations, the batch writer 100 can receive power using the communications interface 108, or a wireless charging device, among other things.

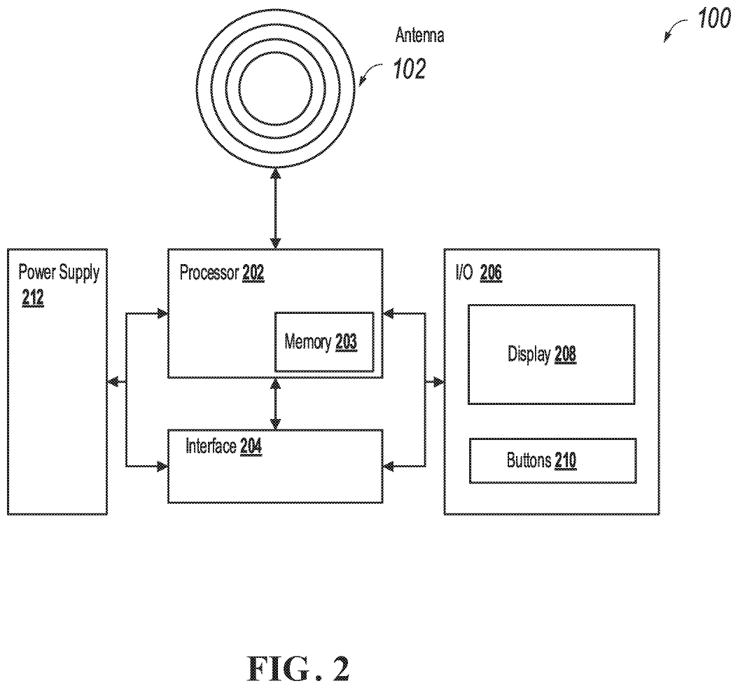

FIG. 2 is a simplified schematic block diagram of an example batch NFC writer and database manager 100. Database manager 100 includes one or more processors 202, an interface 204, various I/O devices 206 such as a display 208 and/or buttons 120, and a power supply 212. Database manager 100 further includes an NFC antenna 102 operable to communicate using the NFC protocol with NFC tags within the effective range of the NFC antenna 102.

In some implementations, NFC antenna 102 is a coil of conductor (e.g., copper) that is configured to receive and/or transmit at 13.56 Mhz. In some implementations, NFC antenna 108 has a square or rectangular configuration. As illustrated, NFC antenna 102 can have a circular configuration. In some implementations, NFC antenna 102 is printed on a printed circuit board (PCB). In some implementations, NFC antenna 108 is included in a shared housing with the rest of the batch NFC writer 100, and in some implementations it is a separate component. For example, NFC antenna 102 may be embedded in a wand or other device that is communicatively coupled to NFC batch writer 100.

Processor 202 can enable computational operations of batch writer 100. Although illustrated as a single processor 202 in FIG. 2, multiple processors can be used according to particular needs, desires, or particular implementations of the batch writer 100. Each processor 202 can be a central processing unit (CPU), an application specific integrated circuit (ASIC), a field-programmable gate array (FPGA), or another suitable component. Generally, the processor 202 executes instructions and manipulates data to perform the operations of the batch writer 100. Specifically, the processor 202 executes the algorithms and operations described in the illustrated figures, as well as the various software and functionality, including the functionality for sending communications to and receiving transmissions from the NFC tag 110, as well as to other devices and systems. Each processor 202 can have a single or multiple core, with each core available to host and execute an individual processing thread. Further, the number of, types of, and particular processors 202 used to execute the operations described herein can be dynamically determined based on a number of requests, interactions, and operations associated with the transaction processor 202, for example, when processor 202 is hosted on cloud based system.

Regardless of the particular implementation, “software” includes computer-readable instructions, firmware, wired and/or programmed hardware, or any combination thereof on a tangible medium (transitory or non-transitory, as appropriate) operable when executed to perform at least the processes and operations described herein. In fact, each software component can be fully or partially written or described in any appropriate computer language including C, C++, JavaScript, Java™, Visual Basic, assembler, Perl®, any suitable version of 4GL, as well as others.

Processor 202 can include memory 203. Memory 203 can store instructions for processor 202, and can be for example, a flash memory, or EEPROM, or other memory type. Memory 203 can represent a single memory or multiple memories. The memory 203 can include any memory or database module and can take the form of volatile or non-volatile memory including, without limitation, magnetic media, optical media, random access memory (RAM), read-only memory (ROM), removable media, or any other suitable component. In general, memory 203 stores operating instructions for processor 202, and can include a database of cartridge types and settings. For example, memory 202 can store a database of operation settings, including heat intensity, duration, and frequency associated with a number of different cartridges. In some implementations, the processor 202 can periodically update this database by communicating with an external system via interface 204. Interface 204 can be a serial interface such as a universal serial bus (USB) type C, or other connection. In some implementations, interface 204 serves a dual purpose of providing external communications, as well as electrical power supply 212.

Interface 204 can be a wired or wireless interface. For example, interface 204 can include communications interface 108 as illustrated in FIG. 1. The interface 204 is used by the processor 202 for communicating with other systems in a distributed environment including user devices 112. Generally, the interface 204 comprises logic encoded in software and/or hardware in a suitable combination and operable to communicate. More specifically, the interface 204 can comprise software supporting one or more communication protocols associated with communications to enable a network and/or other device's hardware to be operable to communicate physical signals within and outside of the illustrated batch writer 100.

The batch writer 100 includes a power supply 212, which provides electrical power to processor 202, interface 204, and other components (e.g., display 208, antenna 102, etc.). In some implementations, the power supply 212 includes a battery, such as a lithium ion (Li-ion), nickel metal hydride (NiMH), Alkaline, or other battery. In some implementations, the battery is user replaceable. In some implementations, the battery is integrated with the body of batch writer 100. Power supply 212 can also include charging circuitry required for recharging the battery. A charging port (not shown) can be provided on the batch writer 100, to allow recharging of the power supply 212. The charging port can be, for example, a USB-C, Micro-USB, 2.5 mm port, or other suitable port for providing electrical power and/or data to the batch writer 100.

Batch writer 100 includes one or more input/output (I/O) devices 206. The I/O 206 can include a display 208, and one or more buttons 210. In some implementations, the I/O 206 is exclusively provided by external devices (e.g., user devices 112 of FIG. 1) via the interface 204. In some implementations, batch writer 100 includes a dedicated display 208, which can be an a display device such as a CRT (cathode ray tube) or LCD (liquid crystal display) monitor or screen for displaying information to the user. Buttons 210 or other I/O devices can include keyboard and a pointing device such as a mouse or a trackball by which the user can provide input to the batch writer 100. Additionally, such activities can be implemented via touchscreen flat-panel displays and other appropriate mechanisms. In some implementations, buttons 210 include a connect, start, stop, select, left, right, up, down, power, or other appropriate buttons.

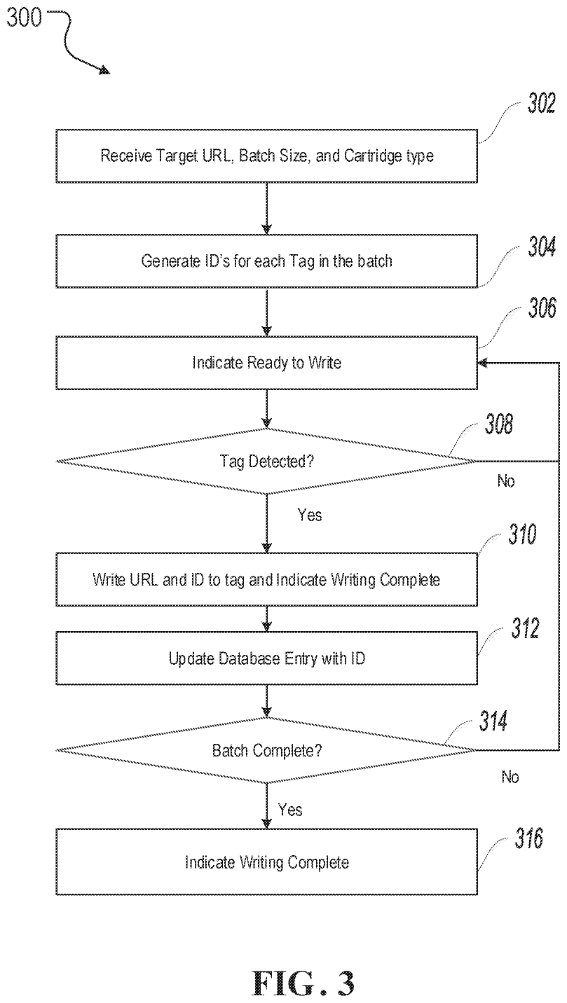

FIG. 3 is a flowchart illustrating an example process 300 for batch writing NFC tags. It will be understood that process 300 and related methods may be performed, for example, by any suitable system, environment, software, and hardware, or a combination of systems, environments, software, and hardware, as appropriate. For example, a system comprising a communications module, at least one memory storing instructions and other required data, and at least one hardware processor interoperably coupled to the at least one memory and the communications module can be used to execute process 300. In some implementations, the process 300 and related methods are executed by one or more components of the batch writer 100 described above with respect to FIGS. 1 and 2.

At 302, a target URL, batch size, and cartridge type are received. A user or external system can input a target URL at which the database to be populated is to be stored. In general, the target URL can point to a landing page for a specific manufacturer, distributer, or reseller, and can be accessible by any device with web browsing capabilities. For example, the URL can specify a target domain, that with an additional ID, can point to particular settings or parameters associated with that ID. An example URL format might be: http://domain.com/cartridgeID, where the cartridgeID is a 15-digit UPID number that is uniquely generated for a specific cartridge. The batch size specifies a number of NFC tags, or cartridges containing NFC tags that will be written to. Cartridge type can include the specific kind of cartridge the tags that are being written to will be, and can include parameters such as fluid amount, fluid type, target vaporization power, onboard sensor amount and type, etc. An example of an input at 302 could be: http://website.com/; 450; 0.7 ml, 50 mg nicotine. This input would indicate that the database being updated is at the domain “website.com” and a batch of 450 NFC tags will be written with settings for a 0.7 ml, 50 mg nicotine cartridge. This input can be provided to the batch writer by a user via keyboard or onboard buttons, or using a remote device in communications with the batch writer. In some implementations, the input is provided automatically, for example, by a manufacturing machine that installs NFC tags within personal vaporizer cartridges.

In some implementations, 302 can be automated. For example, the URL, cartridge type, batch size, and other parameters can be provided to the batch writer by a manufacturing device or from a remote system based on other manufacturing or logistics processes. In some implementations, the entire process 300 is automated, and the batch writer itself is integrated into a production/logistics chain, such that when new cartridges are manufactured, an on-board NFC chip on the cartridge is automatically written, and a database detailing the particular cartridge is updated without user input.

At 304, the batch writer generates a unique ID for each NFC tag to be written to in the batch. The ID can be generated using a number of processes. For example, a hash of the input with a sequence number (e.g., 3 of 450) or similar can be generated for each NFC tag. Other common processes, such as universally unique identifiers (UUIDs) can be used.

Once a unique ID is generated for each NFC tag to be written, at 306 the batch writer indicates it is ready to begin writing. This can include providing a message on a display, or illuminating an indicator (e.g., a green LED). Upon indicating readiness, the batch writer can begin monitoring for whether there is an NFC tag in communications range with the batch writer. This monitoring can include, for example, periodic polling or transmission of interrogation signals, where if a response is received it indicates that an NFC tag is available for writing. In the previous implementations, the NFC antenna of the batch writer is used to detect whether a tag is in range. In some implementations, separate sensors can be used. For example, an IR proximity sensor can be used, or ultrasonic sensor, among other things, to detect whether an object is within range of the NFC batch writer.

At 308, if a tag is not detected for writing, process 300 returns to 306 and continues to monitor for the presence of a tag. In some implementations, an input from a user or external system can cancel writing, and process 300 ends. However, if a tag is detected, process 300 proceeds to 310.

At 310, the target URL and unique ID are written to the NFC tag, and an indication of writing complete is sent. The indication of writing complete can be, for example, an auditory beep, or a blinking LED, or a dialog message on a display.

At 312, the batch writer updates a database entry, associated the unique ID with the particular NFC tag to which it was just written. In this manner, a database is created that lists a number of unique ID's (obtainable from NFC tags) which can be stored and associated with a particular cartridge type, and one or more settings or parameters associated with the cartridge.

At 314, if the batch writing operations are not complete process 300 returns to 306, and the batch writer continues to monitor for an additional NFC tag to write to.

Once batch writing is complete, at 316, the batch writer indicates writing complete. In some implementations, the batch writer updates the database at this point, making a single, bulk entry as opposed to individual updates for each tag.

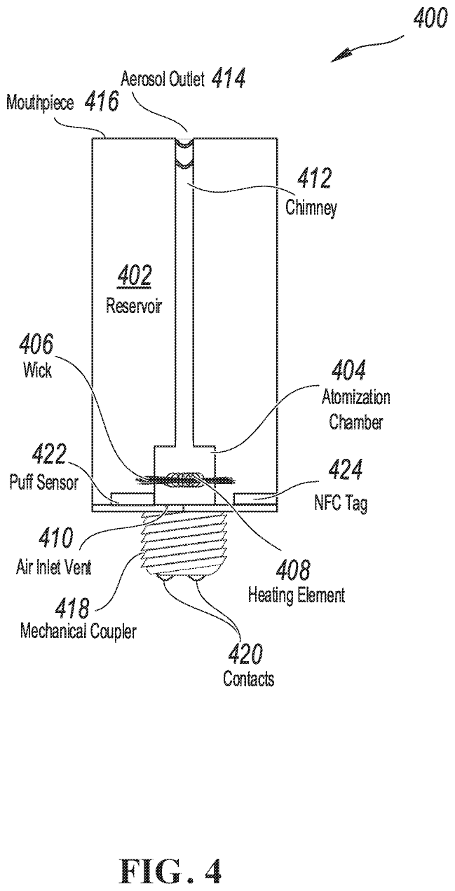

FIG. 4 illustrates a schematic diagram of some internal components of a personal vaporizer cartridge 400. Cartridge 400 includes a reservoir 402 and an atomization chamber 404. The atomization chamber 404 receives a primary substance in liquid form from the reservoir 402 via the wick 406. The wick 406 can be a fibrous bundle that draws liquid via capillary action from the reservoir 402. The wick 406 extends from the primary reservoir into the atomization chamber 404. It can be formed of a suitable heat-resistant wicking material, such as aramid, fluorocarbon, sulfide, melamine, polyimide, carbon, glass fibers, or any combination thereof. The heating element 408 can be a resistive coil that generates heat when electrical current passes through it. The heating element 408 can be supplied with electrical power from a power supply portion of the personal vaporizer. The heating element 408 is located proximal to the wick 406 (in the example illustrated in FIG. 4 it is wrapped around the wick 406). Heating element 408 heats the liquid carried from the primary reservoir 402 by the wick 406 and atomizes the primary substance which mixes with air in the atomization chamber to form an aerosol. One or more air inlet vents 410 near the bottom of the cartridge 400 allow airflow from the air inlet vent 410, through the atomization chamber 404 and out the chimney 412.

Chimney 412 provides a flow path from the air inlet vent 410, through the atomization chamber 404, and out the aerosol outlet 414 in the mouthpiece 416 portion of the cartridge 400. Mechanical coupler 418, illustrated as a threaded device, can include one or more electrical contacts 420, which are configured to mate with corresponding contacts on the power supply. Cartridge 400 can include one or more puff sensors 422 which can be, for example, a microphone, or pressure sensor, that transmits a “puff” signal to the controller to enable the power supply to activate the heating element 408 when a user induces airflow through the cartridge 400. In some implementations, sensor data is transmitted from the cartridge 400 to the power supply wirelessly, e.g., using Bluetooth Low Energy, or ZigBee. In some implementations, sensor data (e.g. temperature data, puff data, or other information) is transmitted via contacts 420.

Each cartridge 400 can include an NFC tag 424 that includes an antenna, and a circuit (e.g., an integrated circuit) that is configured to transmit NFC signals. The NFC tag 424 can be, for example, an NXP NTAG 5 or similar device. In some implementations, the NFC tag 424 is a sticker, or a small adhesive strip with the antenna embedded into it. When interrogated by an NFC reader or writer (e.g., batch writer 100 of FIG. 1), the NFC tag 424 transmits information via a 13.56 Mhz radio signal using a protocol such as ISO/IEC 21481 (NFCIP-2). The NFC tag 424 can be preprogrammed (e.g., at the time of manufacture) to transmit a URL and a unique cartridge ID, which specifies the cartridge contents (e.g., cannabis oil, a THC suspension, tobacco, opium, amphetamines, inhalable insulin, or other recreational or medicinal substances). NFC tag 424 can transmit additional information such as content amount, or desired heating setting, expiration date, or other information. In some implementations, the NFC tag 424 is an active tag, that is, it includes a separate power supply and actively transmits signals using the power supply. In some implementations, NFC tag 424 is a passive device, and is powered by the incoming interrogation signal.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

1. A method comprising:
receiving, at a batch writing device, a target uniform resource locator (URL) and batch size associated with a plurality of near field communication (NFC) tags;
generating a plurality of unique ID's, each unique ID corresponding to a particular NFC tag in the plurality of NFC tags;
detecting, by the batch writing device, the presence of an NFC tag and in response:
generating a unique URL based on the target URL and a particular unique ID;
writing the unique URL to the NFC tag; and
updating a database entry associating the particular unique ID with the detected NFC tag.

2. The method of claim 1, wherein the plurality of NFC tags are associated with a cartridge of a personal vaporizer, the method comprising:
receiving a cartridge type associated with the plurality of NFC tags; and
generating the unique URL based on the cartridge type.

3. The method of claim 1, wherein updating the database entry comprises generating a new database entry.

4. The method of claim 1, comprising sending a completion message upon writing each unique URL to each NFC tag.

5. The method of claim 1, wherein the database is a web based database, and wherein the batch writing device updates the database entry via a network.

6. The method of claim 1, wherein the unique URL points to a webpage that is specific to the particular unique ID.

7. The method of claim 6, wherein the webpage comprises settings associated with a cartridge of a personal vaporizer.

8. A system for batch writing NFC tags comprising:
a database; and
a batch writer configured to:
receive, a target uniform resource locator (URL) and batch size associated with a plurality of near field communication (NFC) tags;
generate a plurality of unique ID's, each unique ID corresponding to a particular NFC tag in the plurality of NFC tags;
detect, the presence of an NFC tag and in response:
generate a unique URL based on the target URL and a particular unique ID;
write the unique URL to the NFC tag; and
update a database entry associating the particular unique ID with the detected NFC tag.

9. The system of claim 8, wherein the plurality of NFC tags are associated with a cartridge of a personal vaporizer, and wherein the batch writer is further configured to:
receive a cartridge type associated with the plurality of NFC tags; and
generate the unique URL based on the cartridge type.

10. The system of claim 8, wherein updating the database entry comprises generating a new database entry.

11. The system of claim 8, comprising sending a completion message upon writing each unique URL to each NFC tag.

12. The system of claim 8, wherein the database is a web based database, and wherein the batch writer updates the database entry via a network.

13. The system of claim 8, wherein the database stores a plurality of cartridge settings associated with different cartridge types.

14. The system of claim 8, wherein the unique URL points to a webpage that is specific to the particular unique ID.

15. A non-transitory computer-readable storage medium coupled to one or more processors and having instructions store thereon which, when executed by the one or more processor, cause the one or more processors to perform operations comprising:
receiving, at a batch writing device, a target uniform resource locator (URL) and batch size associated with a plurality of near field communication (NFC) tags;
generating a plurality of unique ID's, each unique ID corresponding to a particular NFC tag in the plurality of NFC tags;
detecting, by the batch writing device, the presence of an NFC tag and in response:
generating a unique URL based on the target URL and a particular unique ID;
writing the unique URL to the NFC tag; and
updating a database entry associating the particular unique ID with the detected NFC tag.

16. The non-transitory medium of claim 15, wherein the plurality of NFC tags are associated with a cartridge of a personal vaporizer, the method comprising:
receiving a cartridge type associated with the plurality of NFC tags; and
generating the unique URL based on the cartridge type.

17. The non-transitory medium of claim 15, wherein updating the database entry comprises generating a new database entry.

18. The non-transitory medium of claim 15, comprising sending a completion message upon writing each unique URL to each NFC tag.

19. The non-transitory medium of claim 15, wherein the database is a web based database, and wherein the batch writing device updates the database entry via a network.

20. The non-transitory medium of claim 15, wherein the unique URL points to a webpage that is specific to the particular unique ID.
